(19) United States
(12) Patent Application Publication
(10) Pub. No.: US 2024/0077888 A1
(43) Pub. Date: Mar. 7, 2024

(54) METHOD AND APPARATUS FOR PLATOONING USING UWB-BASED SECURITY AUTHENTICATION

(71) Applicants: Hyundai Motor Company, Seoul (KR); Kia Corporation, Seoul (KR)

(72) Inventors: Dong Hyun HA, Seoul (KR); Jung Hun CHOI, Hwaseong-si (KR)

(73) Assignees: Hyundai Motor Company, Seoul (KR); Kia Corporation, Seoul (KR)

(21) Appl. No.: 18/102,896

(22) Filed: Jan. 30, 2023

(30) Foreign Application Priority Data
Sep. 1, 2022 (KR) 10-2022-0110579

(51) Int. Cl. G05D 1/02; H04L 9/40; H04W 4/46; H04W 4/80

(52) U.S. Cl. CPC G05D 1/0295; G05D 1/0289; H04L 63/0869; H04L 63/1466; H04W 4/46; H04W 4/80; G05D 2201/0213

(57) ABSTRACT

A method and apparatus of platooning using Ultra Wideband (UWB)-based security authentication is provided. The platooning method performed by a platoon leader vehicle includes: selecting three coordinates present in a path along which the platoon leader vehicle moves, using an Ultra WideBand (UWB) sensor mounted on the platoon leader vehicle; determining a location of a surrounding vehicle using the three coordinates and an estimated distance between the UWB sensor and the surrounding vehicle; performing mutual authentication with the surrounding vehicle, based on the location of the surrounding vehicle; and performing platooning by including the surrounding vehicle in one or more platoon follower vehicles, when the mutual authentication is successful, wherein each of the platoon leader vehicle and the one or more platoon follower vehicles is provided with one or more UWB sensors.

### CROSS-REFERENCE TO RELATED APPLICATIONS

The present application claims priority to Korean Patent Application No. 10-2022-0110579, filed on Sep. 1, 2022, the entire contents of which is incorporated herein for all purposes by this reference.

### BACKGROUND OF THE PRESENT DISCLOSURE

### Field of the Present Disclosure

The present disclosure relates to a method and apparatus of platooning using Ultra Wideband (UWB)-based security authentication. More specifically, the present disclosure relates to a method and apparatus of platooning, which prevent spoofing and merge or separate vehicles using UWB-based security authentication.

### Description of Related Art

The content described below merely provides background information on the present embodiment and does not form the related art.

In general, the term “platooning” means that a plurality of vehicles forming a group shares driving information with each other and drives on a road while considering external environment. One platoon includes a leader vehicle and a follower vehicle. The leader vehicle is a vehicle that leads a platoon at the head of the platoon, and the follower vehicle is a vehicle that follows the leader vehicle.

The follower vehicle of the platoon may keep following the leader vehicle using the driving information of the leader vehicle transmitted through a vehicle-to-vehicle communication method. Thus, a driver of the follower vehicle may freely perform actions indoors other than driving. This platooning can increase the convenience of a driver and enhance the efficiency of transportation.

When a link is formed between vehicles for platooning using GPS, link formation may fail in a tunnel or an overpass because the Global Positioning System (GPS) signal is weak. Furthermore, the platooning using the GPS is vulnerable in terms of security. Therefore, it is necessary to form the link between vehicles for platooning based on UWB.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a platooning method performed by a platoon leader vehicle including: selecting three coordinates present in a path along which the platoon leader vehicle moves, using an Ultra WideBand (UWB) sensor mounted on the platoon leader vehicle; determining a location of a surrounding vehicle using the three coordinates and an estimated distance between the UWB sensor and the surrounding vehicle; performing mutual authentication with the surrounding vehicle, based on the location of the surrounding vehicle; and performing platooning by including the surrounding vehicle in one or more platoon follower vehicles, when the mutual authentication is successful, wherein each of the platoon leader vehicle and the one or more platoon follower vehicles is provided with one or more UWB sensors.

According to an exemplary embodiment of the present disclosure, a platooning apparatus including a memory; and a plurality of processors, wherein at least one of the plurality of processors selects three coordinates present in a path along which a platoon leader vehicle moves, using an UWB sensor mounted on the platoon leader vehicle, determines a location of a surrounding vehicle using the three coordinates and an estimated distance between the UWB sensor and the surrounding vehicle; performs mutual authentication with the surrounding vehicle based on the location of the surrounding vehicle, and performs platooning by including the surrounding vehicle in one or more platoon follower vehicles when the mutual authentication is successful, wherein each of the platoon leader vehicle and the one or more platoon follower vehicles is provided with one or more UWB sensors.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a vehicle control device mounted on a platooning vehicle, according to an exemplary embodiment of the present disclosure.

FIG. 2 is a diagram illustrating a platoon leader vehicle and a platoon follower vehicle, according to an exemplary embodiment of the present disclosure.

FIG. 3 is a diagram illustrating the locations of a platooning vehicle as time elapses, according to an exemplary embodiment of the present disclosure.

FIG. 4 is a diagram illustrating the process of determining the location of a tag using the location of the platooning vehicle as time elapses, according to an exemplary embodiment of the present disclosure.

FIG. 5 is a diagram illustrating the process of defending against a spoofing attack on platooning vehicles, according to an exemplary embodiment of the present disclosure.

FIG. 6 is a diagram illustrating the maintaining of a distance between the platooning vehicles, according to an exemplary embodiment of the present disclosure.

FIG. 7 is a diagram illustrating the process of maintaining the distance between the platooning vehicles, according to an exemplary embodiment of the present disclosure.

FIG. 8 is a diagram illustrating the merging or separation of the platooning vehicles, according to an exemplary embodiment of the present disclosure.

FIG. 9 is a diagram illustrating the process of merging or separating the platooning vehicles, according to an exemplary embodiment of the present disclosure.

FIG. 10 is a diagram illustrating a platooning method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The present disclosure is to provide a method and apparatus, which perform security authentication between platooning vehicles using UWB.

Furthermore, the present disclosure is to provide a method and apparatus, which form a link between platooning vehicles using UWB.

Furthermore, the present disclosure is to provide a method and apparatus, which merge or separate platooning vehicles.

Furthermore, the present disclosure is to provide a method and apparatus, which defend against a spoofing attack on platooning vehicles.

The objectives to be achieved by the present disclosure are not limited to the above-mentioned objectives, and other objectives which are not mentioned will be clearly understood by those skilled in the art from the following description.

Hereinafter, some exemplary embodiments of the present disclosure will be described in detail with reference to the accompanying drawings. In the following description, like reference numerals designate like elements, although the elements are shown in different drawings. Furthermore, in the following description of various exemplary embodiments of the present disclosure, a detailed description of known functions and configurations incorporated therein will be omitted for clarity and for brevity.

Additionally, various terms such as first, second, A, B, (a), (b), etc., are used solely to differentiate one component from the other but not to imply or suggest the substances, order, or sequence of the components. Throughout the present specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is directed to describe exemplary embodiments of the present disclosure, and is not intended to represent the only embodiments in which an exemplary embodiment of the present disclosure may be practiced.

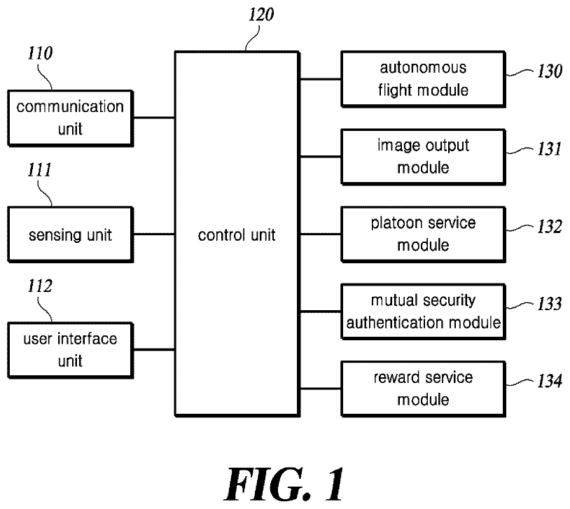

FIG. 1 is a diagram illustrating a vehicle control device mounted on a platooning vehicle, according to an exemplary embodiment of the present disclosure.

Referring to FIG. 1, each platooning vehicle may include a communication unit 110, a sensing unit 111, a user interface unit 112, a control unit 120, an autonomous driving module 130, an image output module 131, a platoon service module 132, a mutual security authentication module 133, and a reward service module 134. The communication unit 110 may transmit and receive information through a communication network between the platooning vehicles. The communication unit 110 may transmit and receive information between the platooning vehicles through at least one communication method among LAN (Wireless LAN), Wireless-Fidelity (Wi-Fi), Wi-Fi (Wireless Fidelity) Direct, DLNA (Digital Living Network Alliance), Wireless Broadband Internet (WiBro), Worldwide Interoperability for Microwave Access (WiMAX), HSDPA (High Speed Downlink Packet Access), HSUPA (High Speed Uplink Packet Access), Long Term Evolution (LTE), and LTE-A (Long Term Evolution-Advanced).

Furthermore, the communication unit 110 may perform short-range communication between the platooning vehicles. Since the platooning vehicles drive while maintaining a short distance between each other, the communication unit 110 may transmit and receive information between the platooning vehicles through short-range wireless communication. In the instant case, the communication unit 110 may transmit and receive various pieces of information between the platooning vehicles through Bluetooth, Radio Frequency Identification (RFID), Infrared Data Association (IrDA), Ultra WideBand (UWB), ZigBee, Near Field Communication (NFC), Wireless-Fidelity (Wi-Fi), Wi-Fi Direct, Wireless Universal Serial Bus (Wireless USB), etc.

The sensing unit 111 may include a radar, a camera, a Light Detection and Ranging (LiDAR), etc. The sensing unit 111 may detect the speed and location of a surrounding platooning vehicle. The sensing unit 111 may detect all objects including obstacles, people, animals, tollgates, and seawalls as well as the platooning vehicle. The user interface unit 112 may provide a user interface to a driver. The user interface unit 112 may receive information from the driver to input the information into the control unit 120 or output a result according to an operation. For example, the driver may input information related to the surrounding platooning vehicle into the user interface unit 112. The user interface unit 112 may input information related to the surrounding platooning vehicle into the control unit 120. The control unit 120 may give a control command to the autonomous driving module 130 using the information related to the surrounding platooning vehicle.

The control unit 120 may control the autonomous driving module 130, the image output module 131, the platoon service module 132, the mutual security authentication module 133, and the reward service module 134 according to the information received from the communication unit 110, the sensing unit 111, and the user interface unit 112. The autonomous driving module 130 may change or maintain the speed and direction of the vehicle according to the control command of the control unit 120. The image output module 131 may output images of a surrounding vehicle, a surrounding obstacle, a surrounding building, and the like to the driver according to the control command of the control unit 120. The platoon service module 132 may provide a service related to platooning to surrounding vehicles according to the control command of the control unit 120. The mutual security authentication module 133 may perform authentication using an identifier (ID) between the surrounding vehicles according to the control command of the control unit 120. The platooning vehicle may defend against the spoofing attack of an attacker through the authentication. The reward service module 134 may provide a mileage, a reward point, etc. to the platooning vehicle according to the control command of the control unit 120.

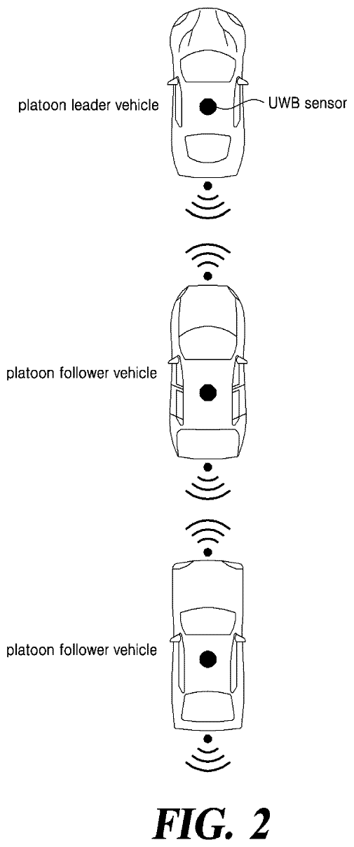

FIG. 2 is a diagram illustrating a platoon leader vehicle and a platoon follower vehicle, according to an exemplary embodiment of the present disclosure.

Referring to FIG. 2, the platoon leader vehicle and the platoon follower vehicle may be present among a plurality of platooning vehicles. The platoon leader vehicle and the platoon follower vehicle may have one or more UWB sensors. The platoon leader vehicle and the platoon follower vehicle may have only one UWB sensor. The platoon leader vehicle and the platoon follower vehicle may correspond to an autonomous vehicle. The platoon leader vehicle may correspond to a general vehicle and not an autonomous vehicle. When the platoon leader vehicle is not an autonomous vehicle but is a general vehicle and is provided with one UWB sensor, such a platoon leader vehicle may implement platooning by controlling platoon follower vehicles. The platoon leader vehicle may give the control command to the platoon follower vehicles. According to the control command, the platooning vehicles may maintain a distance between each other by adjusting a speed or direction thereof. Thus, collision between the platooning vehicles may be prevented. Furthermore, the platooning vehicles may change or maintain lanes by adjusting the speed or direction thereof.

The platoon leader vehicle may be selected by the platoon follower vehicles. The platoon leader vehicle may perform an UWB-based security authentication procedure when the platoon follower vehicle comes within a predetermined distance. When the security authentication is successful, the platoon follower vehicle may automatically perform platooning. The platoon follower vehicle may determine whether to perform platooning through the driver information of the platoon leader vehicle. The platoon follower vehicle may receive customized services by inquiring into the driving style, driving pattern, and driving penalty score of a driver who drives the platoon leader vehicle, or by inquiring into the reviews and evaluations of the platooning. The platoon leader vehicle may provide mileage and reward points to the platoon follower vehicle for each operation. The platoon leader vehicle may provide an additional tip point to the platoon follower vehicle. The platoon follower vehicle may evaluate or write a review on the execution of platooning by the platoon leader vehicle.

When the platoon follower vehicle reaches its destination or desires to cancel platooning, the platoon follower vehicle may cancel the platooning through the UWB. The cancellation may be performed according to platoon cancellation logic. One or more platoon leader vehicles may control the platoon follower vehicles. When the platoon follower vehicle receiving the platooning service ignores the control command or threatens other platoon follower vehicles, the platoon leader vehicle may exclude said platoon follower vehicle from the platooning. The entrance and cancellation of platooning may be performed based on UX (User Experience)/UI (User Interface).

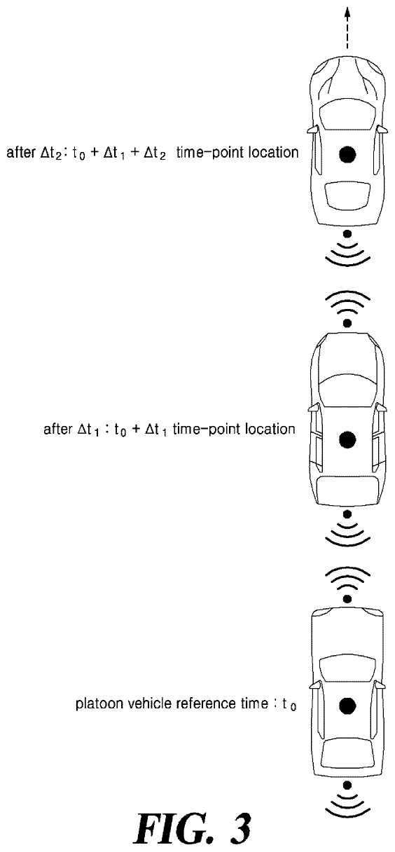

FIG. 3 is a diagram illustrating the locations of a platooning vehicle as time elapses, according to an exemplary embodiment of the present disclosure.

Referring to FIG. 3, the platooning vehicle may depart at time to. The platooning vehicle may be present at a time-point location to at time to. The platooning vehicle may be present at a time-point location t₀+t₁ at time t₀+t₁. The platooning vehicle may be present at a time-point location t₀+t₁+t₂ at time t₀+t₁+t₂. The platooning vehicle may store a path traveled for time t₁+t₂. Furthermore, the platooning vehicle may store a coordinate in the path along which the vehicle moves for time t₁+t₂. The moving path, coordinate, and moving distance per hour may be obtained using the vehicle speed, the direction and angle of the vehicle, the absolute location at time to, odometry, the revolutions per minute (rpm) of a vehicle wheel, a camera deep-learning model, etc.

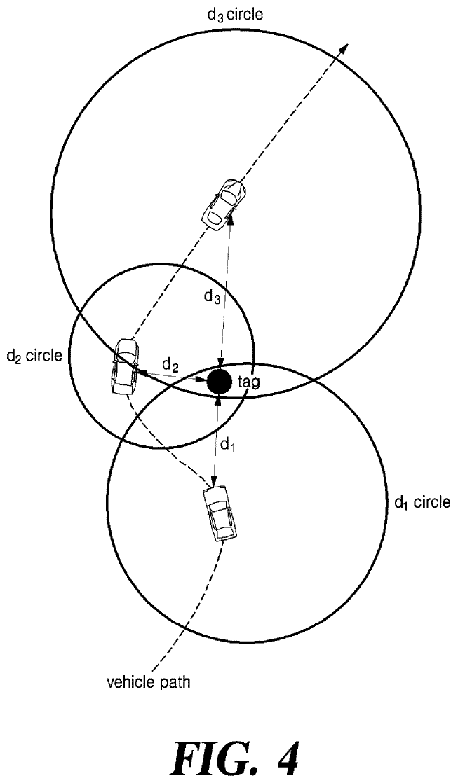

FIG. 4 is a diagram illustrating the process of determining the location of a tag using the location of the platooning vehicle as time elapses, according to an exemplary embodiment of the present disclosure. Trilateration is a method of finding the relative location of an object using triangular geometry. Unlike triangulation which utilizes the length of one side and two angles at both end portions, trilateration utilizes two or more reference points and a distance between an object and each reference point to find a target location. To precisely and uniquely determine a relative location in a two-dimensional plane only by trilateration, at least three reference points are required.

Referring to FIG. 4, the moving path of the vehicle may correspond to a path along which the platooning vehicle of FIG. 3 moves for time t₁+t₂. In the moving path of the vehicle, three coordinates may be selected. The three coordinates may be used in trilateration technique. These three coordinates may be selected using the vehicle speed, the direction and angle of the vehicle, the absolute location at time to, odometry, the rpm of a vehicle wheel, a camera deep-learning model, etc. The distances between the coordinates and the tag may be estimated as d₁, d₂, and d₃, respectively. A d₁ circle, a d₂ circle, and a d₃ circle may be formed using the estimated distances d₁, d₂, and d₃ as radii. The location and coordinate of the tag may be determined using the three coordinates, the d₁ circle, the d₂ circle, and the d₃ circle, and the trilateration technique. The determination may be performed by a calculation processing unit included in the platooning vehicle.

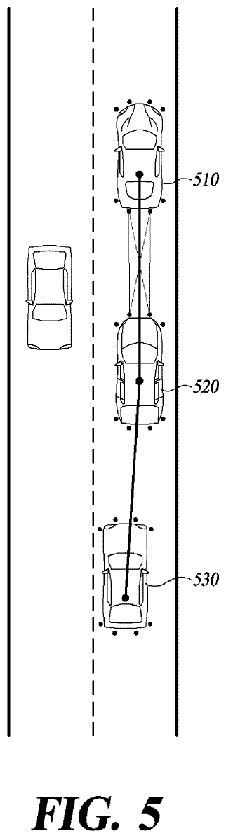

FIG. 5 is a diagram illustrating the process of defending against a spoofing attack on platooning vehicles, according to an exemplary embodiment of the present disclosure. The spoofing attack may correspond to a hacking technique in which an external malicious attacker utilizes a structural defect or obtains a user's system authority to steal information. Thus, when the UWB link is formed or information exchange is performed between platooning vehicles, communication security is essential for safety. Since the platooning vehicles perform mutual authentication based on the UWB and share location information with each other, information sharing and mutual authentication may also be performed in a tunnel, an overpass and around a bridge pillar. The platooning vehicles may use the UWB to detect an object such as a vehicle or an obstacle which is not visible in a blind spot.

Referring to FIG. 5, a first platooning vehicle 510 and a second platooning vehicle 520 may exchange information with each other by forming the UWB link. Each of the first platooning vehicle 510 and the second platooning vehicle 520 has at least one UWB sensor. The first platooning vehicle 510 may store the moving path and coordinates as time elapses and select three coordinates from among the stored coordinates. The first platooning vehicle 510 may determine the location and coordinates of the second platooning vehicle 520 using the three selected coordinates and the trilateration technique. To be more specific, the first platooning vehicle 510 may determine the location and coordinates of the second platooning vehicle 520 using the three selected coordinates and the estimated distance between the UWB sensor provided on the first platooning vehicle 510 and the second platooning vehicle 520. The second platooning vehicle 520 may also determine the location and coordinates of the first platooning vehicle 510 in the same method. The first platooning vehicle 510 and the second platooning vehicle 520 may perform mutual security authentication using locations and coordinates of each other. The mutual security authentication may be performed using the ID of each vehicle.

The spoofing attack vehicle 530 may make a spoofing attack on the first platooning vehicle 510 and the second platooning vehicle 520. The spoofing attack vehicle 530 may not perform mutual security authentication with the first platooning vehicle 510 and the second platooning vehicle 520, and it may be recognized as an attack vehicle by the first platooning vehicle 510 and the second platooning vehicle 520. Thus, the spoofing attack vehicle 530 may not steal information between the first platooning vehicle 510 and the second platooning vehicle 520. The spoofing attack vehicle 530 may not obtain the authority of the first platooning vehicle 510 and the second platooning vehicle 520.

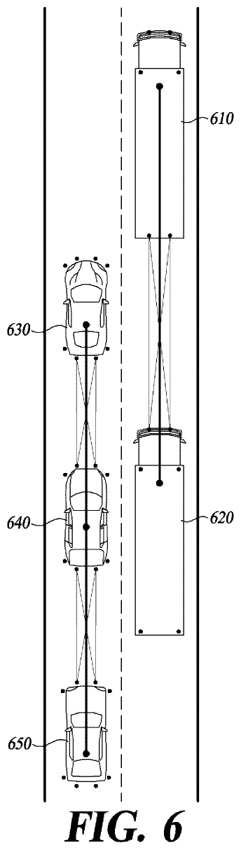

FIG. 6 is a diagram illustrating the maintaining of a distance between the platooning vehicles, according to an exemplary embodiment of the present disclosure.

Referring to FIG. 6, a first platooning truck 610 and a second platooning truck 620 may exchange information with each other by forming a UWB link. Each of the first platooning truck 610 and the second platooning truck 620 has at least one UWB sensor. The first platooning truck 610 and the second platooning truck 620 may perform mutual security authentication using the locations and coordinates of each truck. The mutual security authentication may be performed using the ID of each truck. The first platooning truck 610 and the second platooning truck 620 may share locations and coordinates with each other to determine whether there is a collision risk. The first platooning truck 610 and the second platooning truck 620 may measure distance and speed of each truck and maintain a safe distance so as not to collide with each other.

A first platooning vehicle 630, a second platooning vehicle 640, and a third platooning vehicle 650 may exchange information with each other by forming a UWB link. Each of the first platooning vehicle 630, the second platooning vehicle 640, and the third platooning vehicle 650 has at least one UWB sensor. The first platooning vehicle 630, the second platooning vehicle 640, and the third platooning vehicle 650 may perform mutual security authentication using locations and coordinates of each vehicle. The mutual security authentication may be performed using the ID of each vehicle. The first platooning vehicle 630, the second platooning vehicle 640, and the third platooning vehicle 650 may each share their locations and coordinates to determine whether there is a collision risk. The first platooning vehicle 630, the second platooning vehicle 640, and the third platooning vehicle 650 may measure distance and speed of each vehicle and maintain a safe distance so as not to collide with each other. Information may be exchanged between the truck and the general vehicle by forming the UWB link therebetween without being limited to the type of the vehicle. The safety distance may be maintained so that the truck and the general vehicle do not collide with each other.

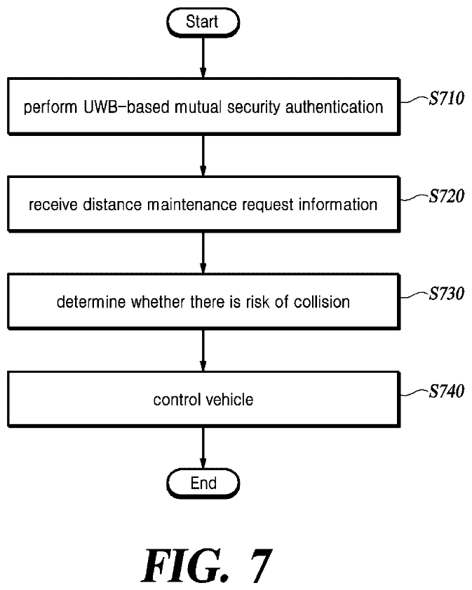

FIG. 7 is a diagram illustrating the process of maintaining the distance between the platooning vehicles, according to an exemplary embodiment of the present disclosure.

Referring to FIG. 7, the platoon leader vehicle may perform the UWB-based mutual security authentication with another vehicle (S710). The platoon leader vehicle may form the UWB link with the other vehicle. The platoon leader vehicle may share locations and coordinates with the other vehicle using the UWB sensor. The platoon leader vehicle may perform mutual authentication with the other vehicle using the location, coordinate, and ID of the other vehicle. When the mutual authentication is successful, the platoon leader vehicle may receive distance maintenance request information from the other vehicle (S720). The platoon leader vehicle may transmit information related to whether to perform platooning to the other vehicle. The other vehicle may select a leading vehicle which is to perform platooning. The other vehicle may agree to receive platooning requests from platooning vehicles at front and rear locations. The other vehicle may transmit information related to platooning authorization to the platoon leader vehicle. The other vehicle may be included in one or more platoon follower vehicles.

The platoon leader vehicle may determine whether there is a risk of collision with the other vehicle (S730). A distance may be determined through the locations and coordinates of the platoon leader vehicle and the other vehicle. The platoon leader vehicle may determine whether there is the risk of collision using the distance to the other vehicle and the speed. The platoon leader vehicle may control the vehicle (S740). The platoon leader vehicle may control the host vehicle (the platoon leader vehicle itself) by determining whether there is a risk of collision with the other vehicle. Moreover, the platoon leader vehicle may give control commands to the other vehicle and platoon follower vehicles driving around the other vehicle.

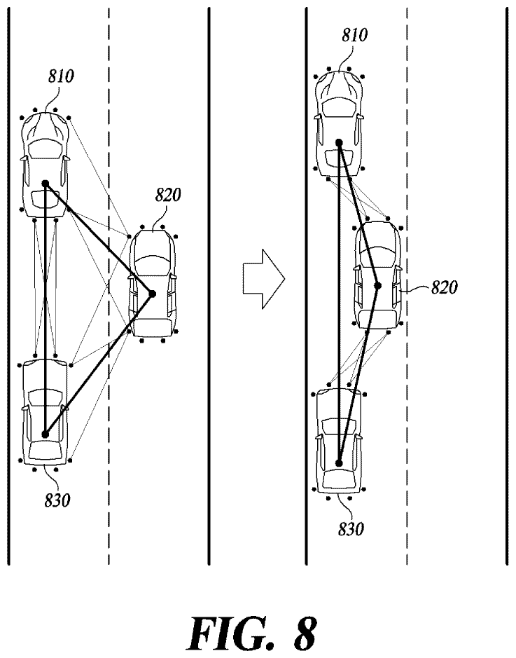

FIG. 8 is a diagram illustrating the merging or separation of the platooning vehicles, according to an exemplary embodiment of the present disclosure.

Referring to FIG. 8, a first platooning vehicle 810, a second platooning vehicle 820, and a third platooning vehicle 830 may exchange information with each other by forming a UWB link. Each of the first platooning vehicle 810, the second platooning vehicle 820, and the third platooning vehicle 830 has at least one UWB sensor. The second platooning vehicle 820 may transmit merging request information to the first platooning vehicle 810 and the third platooning vehicle 830. The first platooning vehicle 810, the second platooning vehicle 820, and the third platooning vehicle 830 may perform mutual security authentication using locations and coordinates of each platooning vehicle. The mutual security authentication may be performed using the ID of each vehicle. The first platooning vehicle 810 and the third platooning vehicle 830 may determine whether there is a collision with the second platooning vehicle 820 when the second platooning vehicle 820 changes lanes to merge. The first platooning vehicle 810 and the third platooning vehicle 830 may increase a distance between each other in preparation for the merging of the second platooning vehicle 820. Here, the first platooning vehicle 810 may increase speed, and the third platooning vehicle 830 may reduce speed. When the distance between the first platooning vehicle 810 and the third platooning vehicle 830 increases, the second platooning vehicle 820 may change lanes to enter between the first platooning vehicle 810 and the third platooning vehicle 830. Thus, the first platooning vehicle 810, the second platooning vehicle 820, and the third platooning vehicle 830 may drive on the same lane.

Subsequently, the second platooning vehicle 820 may transmit separation request information to the first platooning vehicle 810 and the third platooning vehicle 830. When the second platooning vehicle 820 changes lanes to be separated from the first platooning vehicle 810 and the third platooning vehicle 830, it may be determined whether there is a collision with the second platooning vehicle 820. The first platooning vehicle 810 and the third platooning vehicle 830 may increase a distance therebetween in preparation for the separation of the second platooning vehicle 820. Here, the first platooning vehicle 810 may increase speed, and the third platooning vehicle 830 may reduce speed. When the distance between the first platooning vehicle 810 and the third platooning vehicle 830 increases, the second platooning vehicle 820 may change lanes to be separated into a different lane.

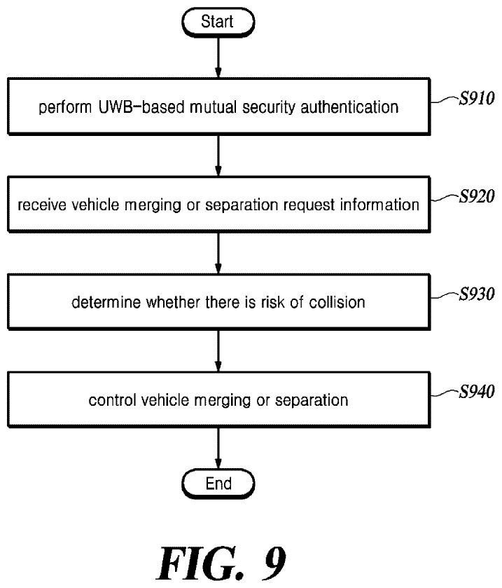

FIG. 9 is a diagram illustrating the process of merging or separating the platooning vehicles, according to an exemplary embodiment of the present disclosure.

Referring to FIG. 9, the platoon leader vehicle and the platoon follower vehicle may perform the UWB-based mutual security authentication (S910). The platoon leader vehicle may form the UWB link with the platoon follower vehicle. The platoon leader vehicle and the platoon follower vehicle may each share their locations and coordinates using the UWB sensor. The platoon leader vehicle and the platoon follower vehicle may perform mutual authentication using the location, coordinate, and ID of the platoon follower vehicle. The platoon leader vehicle may receive vehicle merging or separation request information from the platoon follower vehicle (S920). The platoon leader vehicle may output platoon follower vehicles as an image and then provide the image to a driver. The platoon leader vehicle may activate a platoon merging mode or a platoon separation mode.

The platoon leader vehicle may form the UWB link with another vehicle. The platoon leader vehicle and the other vehicle may each share their locations and coordinates using the UWB sensor. The platoon leader vehicle may perform mutual authentication with the other vehicle using the location, coordinate, and ID of the other vehicle. When the mutual authentication is successful, the other vehicle may be included in the platoon follower vehicles. After the other vehicle is included in the platoon follower vehicles, vehicle merging or separation request information may be transmitted to the platoon leader vehicle.

The platoon leader vehicle may determine whether there is a risk of collision with the platoon follower vehicle (S930). A distance may be determined through the locations and coordinates of the platoon leader vehicle and the platoon follower vehicle. The platoon leader vehicle may determine whether there is the risk of collision using the distance to the platoon follower vehicle and the speed. It may be determined whether there is a risk of collision in anticipation of the merging or separation of the platoon leader vehicle and/from platoon follower vehicle. The platoon leader vehicle may control the vehicle (S940). The platoon leader vehicle may control the host vehicle by determining whether there is a risk of collision with the platoon follower vehicle. Moreover, the platoon leader vehicle may give control commands to the platoon follower vehicle and other platoon follower vehicles driving around the platoon follower vehicle. The platoon leader vehicle may output the process of separating or merging the platoon follower vehicle as an image and then provide the image to a driver.

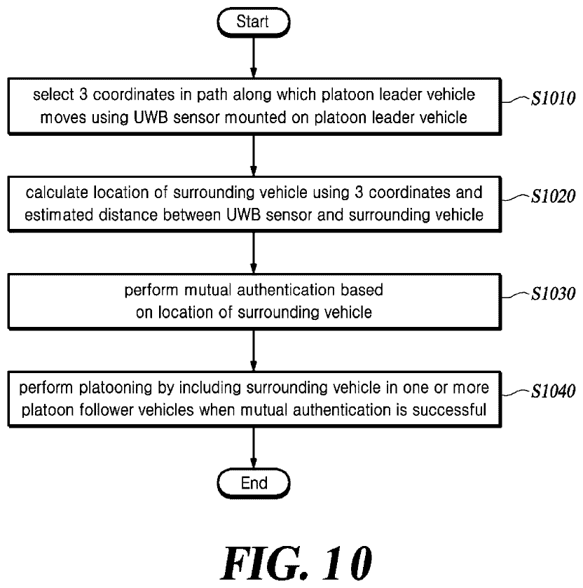

FIG. 10 is a diagram illustrating a platooning method according to an exemplary embodiment of the present disclosure.

Referring to FIG. 10, the platoon leader vehicle may select three coordinates present in the path along which the platoon leader vehicle moves, using the UWB sensor mounted on the platoon leader vehicle (S1010). The platoon leader vehicle may determine the location of a surrounding vehicle using three coordinates and an estimated distance between the UWB sensor and the surrounding vehicle (S1020). The platoon leader vehicle may perform mutual authentication, based on the location of the surrounding vehicle (S1030). When the mutual authentication is successful, the platoon leader vehicle may perform platooning by including the surrounding vehicle in one or more platoon follower vehicles (S1040).

The platoon leader vehicle may receive information related to platooning from one or more platoon follower vehicles. The platoon leader vehicle may determine whether there is a risk of collision with one or more platoon follower vehicles using at least one of the location, speed, and direction of one or more platoon follower vehicles and at least one of the location, speed, and direction of the platoon leader vehicle, based on information related to the platooning. The platoon leader vehicle may give the control command to one or more platoon follower vehicles and control at least one of the speed and direction of the platoon leader vehicle, based on a result of the determination. The spoofing attack from an external attacker may be defended against through the mutual authentication. The information related to the platooning may include one or more of distance maintenance request information, merging request information, and separation request information. The distance maintenance request information may be information requesting to maintain a distance between the platoon leader vehicle and the one or more platoon follower vehicles for preventing a collision between the platoon leader vehicle and one or more platoon follower vehicles. The merging request information may be information that one or more platoon follower vehicles request merging from a lane. The separation request information may be information that one or more platoon follower vehicles request separation from a lane. The platoon leader vehicle may provide the image of the platoon leader vehicle and one or more platoon follower vehicles driving to a terminal of a driver of the platoon leader vehicle. The platoon leader vehicle may offer the mileage or reward point to one or more platoon follower vehicles.

According to an exemplary embodiment of the present disclosure, it is possible to provide a method and apparatus, which perform security authentication between platooning vehicles using UWB.

Furthermore, according to an exemplary embodiment of the present disclosure, it is possible to provide a method and apparatus, which form a link between platooning vehicles using UWB.

Furthermore, according to an exemplary embodiment of the present disclosure, it is possible to provide a method and apparatus, which merge or separate platooning vehicles.

Furthermore, according to an exemplary embodiment of the present disclosure, it is possible to provide a method and apparatus, which defend against a spoofing attack on platooning vehicles.

Effects which may be obtained by the present disclosure are not limited to the above-mentioned effects, and other effects which are not mentioned will be clearly understood by those skilled in the art from the following description.

Each element of the apparatus or method in accordance with various aspects of the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein may be realized with digital electronic circuits, integrated circuits, field programmable gate arrays (FPGAs), application specific integrated circuits (ASICs), computer hardware, firmware, software, and/or combinations thereof. The various embodiments may include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a compact disc ROM (CD-ROM), magnetic tape, a floppy disk, a memory card, a hard disk, or an optical data storage device. Furthermore, the computer-readable recording medium may further include a transitory medium such as a data transmission medium. Furthermore, the computer-readable recording medium may be distributed over computer systems connected through a network, and computer-readable program code may be stored and executed in a distributive manner.

Although operations are illustrated in the flowcharts/timing charts in the present specification as being sequentially performed, this is merely an exemplary description of the technical idea of an exemplary embodiment of the present disclosure. In other words, those skilled in the art to which an exemplary embodiment of the present disclosure belongs may appreciate that various modifications and changes may be made without departing from essential features of an exemplary embodiment of the present disclosure, that is, the sequence illustrated in the flowcharts/timing charts may be changed and one or more operations of the operations may be performed in parallel. Thus, flowcharts/timing charts are not limited to the temporal order.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A platooning method performed by a platoon leader vehicle, the platooning method comprising:
selecting three coordinates present in a path along which the platoon leader vehicle moves, using an Ultra WideBand (UWB) sensor mounted on the platoon leader vehicle;
determining a location of a surrounding vehicle using the three coordinates and an estimated distance between the UWB sensor and the surrounding vehicle;
performing mutual authentication with the surrounding vehicle, based on the location of the surrounding vehicle; and
performing platooning by including the surrounding vehicle in one or more platoon follower vehicles, when the mutual authentication is successful,
wherein each of the platoon leader vehicle and the one or more platoon follower vehicles is provided with one or more UWB sensors.

2. The method of claim 1, wherein the performing platooning includes:
receiving information related to the platooning from the one or more platoon follower vehicles;
determining whether there is a risk of collision with the one or more platoon follower vehicles using at least one of location, speed, or direction of the one or more platoon follower vehicles and at least one of location, speed, or direction of the platoon leader vehicle, based on the information related to the platooning;
giving a control command to the one or more platoon follower vehicles and controlling at least one of the speed or the direction of the platoon leader vehicle, based on a result of the determining whether there is the risk of the collision with the one or more platoon follower vehicles.

3. The method of claim 1, wherein a spoofing attack from an external attacker is defended against through the mutual authentication.

4. The method of claim 2, wherein the information related to the platooning includes one or more of distance maintenance request information, merging request information, and separation request information.

5. The method of claim 4, wherein the distance maintenance request information is information requesting to maintain a distance between the platoon leader vehicle and the one or more platoon follower vehicles for preventing the collision between the platoon leader vehicle and the one or more platoon follower vehicles.

6. The method of claim 4, wherein the merging request information is information that the one or more platoon follower vehicles request to merge from a lane.

7. The method of claim 4, wherein the separation request information is information that the one or more platoon follower vehicles request to separate from a lane.

8. The method of claim 1, further including:
providing an image of the platoon leader vehicle and the one or more platoon follower vehicles driving to a terminal of a driver of the platoon leader vehicle.

9. The method of claim 1, further including:
offering a mileage or a reward point to the one or more platoon follower vehicles.

10. A non-transitory computer readable storage medium on which a program for performing the method of claim 1 is recorded.

11. A platooning apparatus comprising a memory and a plurality of processors,
wherein at least one of the plurality of processors is configured to:
select three coordinates present in a path along which a platoon leader vehicle moves, using an Ultra WideBand (UWB) sensor mounted on the platoon leader vehicle,
determine a location of a surrounding vehicle using the three coordinates and an estimated distance between the UWB sensor and the surrounding vehicle;
perform mutual authentication with the surrounding vehicle based on the location of the surrounding vehicle, and
perform platooning by including the surrounding vehicle in one or more platoon follower vehicles when the mutual authentication is successful,
wherein each of the platoon leader vehicle and the one or more platoon follower vehicles is provided with one or more UWB sensors.

12. The apparatus of claim 11, wherein the at least one of the plurality of processors is further configured to:
receive information related to the platooning from the one or more platoon follower vehicles;
determine whether there is a risk of collision with the one or more platoon follower vehicles using at least one of location, speed, or direction of the one or more platoon follower vehicles and at least one of location, speed, or direction of the platoon leader vehicle, based on the information related to the platooning;
give a control command to the one or more platoon follower vehicles and control at least one of the speed or the direction of the platoon leader vehicle, based on a result of the determining of whether there is the risk of the collision with the one or more platoon follower vehicles.

13. The apparatus of claim 11, wherein a spoofing attack from an external attacker is defended against through the mutual authentication.

14. The apparatus of claim 12, wherein the information related to the platooning includes one or more of distance maintenance request information, merging request information, and separation request information.

15. The apparatus of claim 14, wherein the distance maintenance request information is information requesting to maintain a distance between the platoon leader vehicle and the one or more platoon follower vehicles for preventing the collision between the platoon leader vehicle and the one or more platoon follower vehicles.

16. The apparatus of claim 14, wherein the merging request information is information that the one or more platoon follower vehicles request to merge from a lane.

17. The apparatus of claim 14, wherein the separation request information is information that the one or more platoon follower vehicles request to separate from a lane.

18. The apparatus of claim 11, wherein the at least one processor is configured to provide an image of the platoon leader vehicle and the one or more platoon follower vehicles driving to a terminal of a driver of the platoon leader vehicle.

19. The apparatus of claim 11, wherein the at least one processor offers a mileage or a reward point to the one or more platoon follower vehicles.
